(19) United States
(12) Patent Application Publication
(10) Pub. No.: US 2006/0233662 A1
(43) Pub. Date: Oct. 19, 2006

(54) Support element for use in the analysis of substances

(76) Inventors: Mirko Lehmann, Freiburg (DE); Ulrich Sieben, Reute (DE)

Correspondence Address: Patrick J O'Shea;O'Shea Getz & Kosakowski, Suite 912, 1500 Main Street, Springfield, MA, 01115, US

(21) Appl. No.: 10/569,329

(22) PCT Filed: Aug. 19, 2004
(86) PCT No.: PCT/EP04/09301

§ 371 Date: Apr. 7, 2006

(30) Foreign Application Priority Data
Aug. 19, 2003 (DE) 10338101.5

(51) Int. Cl. G01N 31/22

(52) U.S. Cl. 422/56

(57) ABSTRACT

In a carrier medium having at least two defined regions, biological and/or chemical substances are applied to the regions of the carrier medium for analyzing an analyte. The carrier medium is also provided with a stored code that indicates which biological and/or chemical substance is located in which defined region. The application of multiple biological and/or chemical substances to one carrier medium enables multiple analyses to be performed simultaneously on the analyte. This approach reduces the required quantities of the biological and/or chemical substances needed to perform the desired analyses of the analyte. The carrier medium itself does not reveal which biological and/or chemical substance is located in which region; this information may instead be provided by the code.

### PRIORITY INFORMATION

This patent application claims priority from International patent application PCT/EP2004/009301 filed Aug. 19, 2004, German patent application 103 38 101.5 filed Aug. 19, 2003, and U.S. patent application Ser. No. 10,743,263 filed Dec. 22, 2003, which are hereby incorporated by reference.

### BACKGROUND OF THE INVENTION

The present invention relates in general to the field of testing for various physical conditions, and in particular to a carrier medium for analyzing an analyte.

Carrier media are known which are used for testing an analyte for a specific condition. To this end, a biological or chemical substance is applied to the carrier medium, the substance either reacting or not reacting upon contact with the analyte substance being tested, depending on the presence or absence of a corresponding specific physical condition. Typically, the reaction is manifested by a color change in the carrier medium. Known carrier media include, for example, those which, when they come in contact with a liquid, change color in response to the pH of the liquid, or carrier media which, upon contact with urine, indicate whether or not a pregnancy is present. Carrier media coated with an antibody are able to verify through a color reaction whether or not the associated viruses are present in the blood of a patient.

A disadvantage of carrier media of this type is that an analyte may be tested only for a single condition per carrier medium. If a number of analyses for different conditions are to be made on the analyte, a time-consuming and costly analysis at a physician's office is required involving multiple carrier media and a large quantity of the analyte such as blood or urine.

What is needed is a single carrier medium that is suitable for multiple analyses, thereby offering a method of analysis that is convenient, saves time and expense, and requires smaller quantities of biological or chemical material substances and analytes to carry out the multiple analyses.

### SUMMARY OF THE INVENTION

In a carrier medium having at least two defined regions, biological and/or chemical substances are applied to the regions of the carrier medium for analyzing an analyte. The carrier medium is also provided with a code that indicates which biological and/or chemical substance is located in which defined region. The application of multiple biological and/or chemical substances to one carrier medium enables multiple analyses to be performed simultaneously on the analyte. This approach reduces the required quantities of the biological and/or chemical substances needed to perform the desired analyses of the analyte. The carrier medium itself does not reveal which biological and/or chemical substance is located in which region; this information may instead be provided by the code.

Several hundred biological and/or chemical substances may be applied in a corresponding number of defined regions on the medium. As a result, several hundred analyses may be performed simultaneously on an analyte such as blood or urine, using a single carrier medium, thereby saving considerable time and expense.

The biological and/or chemical substances may be arranged differently within the defined regions on two different carrier media. As a result, it may not be possible to draw conclusions from the arrangement of the biological and/or chemical substances on one carrier medium about the corresponding arrangement of biological and/or chemical substances on a second carrier medium. It is by reading the code on a particular carrier medium that it may be possible to determine which biological and/or chemical substance is located in which region on that particular medium.

The defined regions may be arranged differently on two different carrier media. As a result, it may not be possible to draw conclusions from the arrangement of the defined regions on one carrier medium about the arrangement of the defined regions on a second carrier medium. This provides an additional mechanism of encoding.

A temperature sensor for detecting ambient temperature may be provided on the carrier medium to record any storage of the carrier media at excessively high or low temperatures.

The code may be a barcode, a numerical code, or an alphanumeric code, or the code may be provided by the arrangement of the defined regions on the carrier medium. This last implementation variant for the code may be useful when no space is provided on the carrier medium for a barcode or other type of discrete code.

The code may provide information to a device reading the carrier medium as to how the device should read the defined regions. For example, if certain biological and/or chemical substances respond in a completely different wavelength region than other biological and/or chemical substances, the code may contain this information and instruct the reading device to set specific detectors for the reading in accordance with the expected wavelengths to be detected.

The code may contain information about the expiration date of the carrier medium. After specific storage periods, certain biological and/or chemical substances react to form different substances and, as a result, may no longer be used for the designated analyses. As such, the code may pass on the appropriate information to a device reading the carrier media such that a corresponding warning may be issued by the reading device if a carrier medium is used after the expiration date.

The code may contain information about the storage of the carrier medium from the time of manufacture to the time the carrier medium was used. For example, certain biological and/or chemical substances typically may not be stored above or below specific temperatures, as otherwise certain undesirable reactions occur. Thus, the carrier medium may contain means for detecting the ambient temperature whereby if certain temperatures are exceeded, either on the high side or low side, these variations are stored in the code. If such a carrier medium is nonetheless used for an analysis, the reading device is able to detect based on the code that the carrier medium has not been stored according to specification and issue a warning to this effect.

The carrier medium may be composed of a film strip, glass carrier, or paper.

The biological and/or chemical substances may be DNA, RNA, proteins, or antibodies. As a result, analyses may be performed focusing on bacteria or viruses.

In a preferred embodiment of the invention, at least one additional code is provided which is assigned or assignable to a person or a group of persons. For example, this additional code can be assigned to one patient such that when this code is read the system automatically recognizes to which patient the given carrier medium is to be assigned. Alternatively or additionally, this additional code can also be employed to identify a specific group of persons, for example to identify diabetes patients. This aspect is particularly advantageous if this disease affects the evaluation of the biological or chemical substances reacting with the substance to be analyzed on the carrier medium since this fact can be recognized automatically and appropriately taken into account during the evaluation. Of course, the assignment to persons or groups of persons is not limited to patients or groups of patients but can also be implemented for other persons such as physicians, for example.

The assignment may be implemented in two different ways. In the first approach, the carrier medium is first provided with an additional code—for example, a number or a symbol—which is not initially assigned to a person or group of persons but is assigned to a person or group of persons, for example by assigning to a patient a patient number which is already provided as an additional code on a carrier media and subsequently functions to assign these carrier media to this patient. In these cases, the additional code is assignable to a person or a group of persons. In another approach, carrier media can also be provided, either alternatively or additionally, with an additional code that is assigned from the beginning to a person or a group of persons. This code can include, for example, a fingerprint of a patient or an attending physician or a person's DNA sequence. In these cases, the additional code already assigned to a person or a group of persons is assigned to this carrier medium when applied to this carrier medium, thereby creating the link to the specific person or the group of persons.

Advantageously, at least one additional code is integrated into the code that indicates which biological and/or chemical substance is located in which of the defined regions. As a result, information about the arrangement of the biological and/or chemical substances as well as the contents of the additional codes can be read simultaneously. If the code describing the arrangement of the biological and/or chemical substances is, for example, a bar code, this bar code can form a segment of a comprehensive bar code that simultaneously comprises additional codes.

Another carrier medium according to the invention for analyzing a substance to be analyzed on which biological and/or chemical substances are applied in at least two defined regions has at least one code that is assigned or assignable to a person or group of persons. This aspect is useful when a code describing which biological and/or chemical substance is located at which site on the support is not required, whereas a code which is assigned or assignable to a person or group of persons is nevertheless desired. This may be the case, for example, when the biological and/or chemical substances are always arranged in the same manner on the carrier medium.

The codes employed here correspond to the above-described codes so that these are assigned or are assignable to a person or group of persons analogously to the approach above. In particular, here again a code can be created by a fingerprint.

A method for producing the carrier media comprises the following steps:

a. producing a set of carrier media having a first arrangement of the defined regions and/or a first arrangement of the biological and/or chemical substances within the defined regions;

b. assigning a different code to each of these carrier media in the set;

c. storing the arrangement of the defined regions and/or the arrangement of the biological and/or chemical substances within the defined regions of the carrier media along with the associated codes;

d. selecting a second arrangement of the defined regions, and/or of the biological and/or chemical substances in the defined regions, that is different from the first arrangement;

e. implementing steps a through c for the second arrangement; and

f. implementing steps a through c for subsequent arrangements different from the arrangements previously used.

This production method ensures that each individual carrier medium produced receives a different code, and that the code is stored along with the associated arrangement of defined regions and/or with the arrangement of biological and/or chemical substances in the defined regions. While a certain number of carrier media are thus produced which have an identical arrangement of defined regions, and/or of biological and/or chemical substances in the defined regions, nevertheless these carrier media are differentiated by their corresponding codes, with the result that no two carrier media identical in every respect are produced, and when two carrier media are compared it is likely not possible to detect which biological and/or chemical substance is located in which defined region.

The code may be provided by a simple numbering of the carriers. A code of this type may be the simplest means of providing the different carrier media with different codes.

The biological and/or chemical substances may be printed on the defined regions of the carrier media with a print head analogous to that used in an inkjet printing process. As a result, the carrier media may be produced in a relatively inexpensive manner, while the defined regions are able to be locally placed with high precision on the carrier media.

One set may comprise approximately 1,000 to 10,000 carrier media and several hundred different sets may be produced. As a result, a large number of carrier media are produced whereby the carrier media are present in different forms.

One type of carrier medium may be selected from each of the various sets, and these selected carrier media may be packaged together. As such, one pack contains carrier media with different arrangements and, as a result, it may not be possible to draw conclusions from the arrangement on one carrier medium about the arrangement of a second carrier medium in the same pack. Since the various packs may be distributed throughout a given country, or are even distributed worldwide, the probability that a given user may receive carrier media having identical arrangements (although with different codes) is extremely low.

Alternatively, multiple sets of carrier media may be mixed and randomly selected for inclusion in a common pack. As such, two carrier media with identical arrangements may be included in one pack, although the probability of this occurring is relatively low given a sufficient number of different sets.

A device for reading a carrier medium has at least one optical detector per defined region. The optical detectors detect the reactions of the biological and/or chemical substances in the defined regions when the carrier medium has been brought into a read position relative to the device.

The device may have means for acquiring and transmitting the code to an administrative center. The device itself may not be able to determine the arrangement of the carrier medium read from the code if the arrangement of the defined regions, and/or the arrangement of biological and/or chemical substances within the defined regions, along with the associated codes, are not stored within the reading device. As such, it may be necessary to transmit the code to an administrative center in which the specific arrangement corresponding to the extracted code is determined. The device itself may only be able to detect in which defined region a reaction of the biological and/or chemical substances has occurred in response to the analyte; it may not, however, be able to indicate which biological and/or chemical substance has reacted.

The optical detectors of the device may be semiconductor chips.

Means for digitizing the detected signals and/or transmitting the detected signals to the administrative center may be provided in the device so that the detected signals may undergo subsequent processing.

A method for reading a carrier medium in conjunction with the use of a device for reading the carrier medium comprises the following steps:

a. applying the analyte to the carrier medium;

b. moving the carrier medium into the read position relative to the device for reading the carrier medium;

c. transmitting the code of the carrier medium to an administrative center; and

d. within the administrative center, evaluating the code and determining the associated arrangement.

An advantage of the method for reading a carrier medium is that it provides the manufacturers of the carrier media or of the biological and/or chemical substances, and/or the medical insurance company, with a profitable accounting system. The application of several hundred different biological and/or chemical substances onto a carrier medium means that significantly smaller quantities of these substances are required. The quantities required may be reduced by a factor of between 10⁶ and 10⁹. An accounting system may nevertheless be needed to ensure that the production of these biological and/or chemical substances remains profitable.

The fact that such carrier media are produced in relatively large quantities, since they provide a simple test for certain diseases, bacteria, or viruses, and are thus utilized frequently, does not compensate for the loss generated by the smaller required quantities. For this reason, the method of reading the carrier media may leave evaluation of the carrier media to a central administrative center. Although the carrier media and the device for reading a carrier medium may enable a person to detect reactions of the biological and/or chemical substances to the analyte, the person may not be able to correlate the detected reactions with specific biological and/or chemical substances. To accomplish this, the code may be transmitted from the device for reading a carrier medium to the administrative center at which the arrangement associated with the code may be determined. While the person may be able to determine whether or not a positive reaction of the anaylte to some kind of biological and/or chemical substance has occurred, it may not be possible for the person to determine which biological and/or chemical substance is involved. To cover the cost of production of the carrier media, or of the biological and/or chemical substances, the cost of determining a given arrangement associated with a code may, for example, be accounted for in the administrative center.

However, the evaluation of the code and determination of the associated arrangement within the administrative center may be performed at no cost. As such, a fee may be charged if an analyte has reacted positively to the biological and/or chemical substances. This approach provides a health service that may be implemented in a cost-effective and time-saving manner for the individual but which is also acceptable to the medical insurance companies and the overall healthcare system. The cost-effective availability of the carrier media enables an individual, for example, to test his/her blood or urine on a regular basis for reactions to certain biological and/or chemical substances, whereby a fee may be incurred only if a reaction has occurred; that is, if the person is ill or has a certain condition. The relevant fee or partial fee may, for example, be passed on by the administrative center to the medical insurance companies.

The administrative center may transmit instructions to the reading device as to how the optical detectors are to be set for the specific defined regions. This better ensures a high-quality read-out of the carrier medium.

The method for reading a carrier medium may comprise additional steps. For example, in a step e, the reactions of the defined regions may be detected with the optical detectors adjusted as best as possible.

In a step f, the detected signals may be transmitted to the administrative center. In a step g, the arrangement of the biological and/or chemical substances of the carrier medium, and/or the evaluation of the detected signals may be transmitted from the administrative center to the device for reading.

In the alternative, the reactions of the defined regions may first be detected by the optical detectors of the reading device after step b, and then the detected signals may also be transmitted to the administrative center in step c. The steps related to transmitting the instructions to the reading device may thus be eliminated, although the first reading of the carrier medium may not be performed with the optical detectors adjusted as best as possible.

In the step e, the arrangement of the biological and/or chemical substances of the carrier medium and/or the evaluation of the detected signals may be transmitted from the administrative center to the reading device.

In the alternative, requests may be sent by the administrative center to set certain defined regions in accordance with the detected signals to increase the accuracy of measurement and reduce the probability of error.

A request may be sent by the administrative center, in response to certain detected signals, to read another carrier medium having additional biological and/or chemical substances different from the biological and/or chemical substances on the first carrier medium after application of the analyte. In this way, additional tests may be performed in the case of a reaction to a given biological and/or chemical substance possibly indicating the presence of a certain disease.

The detected signals and the code for the transmission from the reading device to the administrative center may be encrypted with a public key. This measure offers additional security for the data transfer while also providing to the administrative center a means for decrypting the data.

The transmission of the detected signal and code to the administrative center may be error-protection-coded. This measure provides a higher level of security for the data transfer.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 illustrates a first embodiment of a carrier medium;

FIG. 2 illustrates a second embodiment of a carrier medium;

FIGS. 3A and 3B illustrate a third embodiment of a carrier medium;

FIG. 4 is a perspective view of a device for reading the carrier medium of FIGS. 1-3A, 3B;

FIG. 5 illustrates an embodiment of a carrier medium with additional encoding; and

FIG. 6 illustrates an embodiment of a carrier medium having a code assignable to a person or group of persons without a code for the arrangement of biological and/or chemical substances.

### DETAILED DESCRIPTION OF THE INVENTION

Referring to FIG. 1, there illustrated is a carrier medium 10 composed of, e.g., a rectangular film strip on which defined regions 11 are aligned on an essentially square grid 15. The carrier medium 10 may be approximately the size of a check card or credit card. A code 12 may be located on one narrow end of the carrier medium 10, the code being in the exemplary form of a numerical code. The code 12 may be located at any desired site on the carrier medium 10. A barcode or alphanumeric code may be used in place of the numerical code 10.

Biological and/or chemical substances may be applied within the defined regions 11 of carrier medium 10, whereby each of the individual defined regions 11 may contain a different biological and/or chemical substance. Several hundred defined regions 11 may be located on the carrier medium 10 such that the naked eye may not be able to detect the defined regions 11. The naked eye thus may not be able to recognize which biological and/or chemical substance has been applied to which defined region 11. The code 12 may provide information as to which substance is located in which region 11. This information may not, however, be directly accessible to the user of the carrier medium 10.

The carrier medium 10 may have a temperature sensor 17 to record the ambient temperature of the carrier medium 10. Certain biological and/or chemical substances may only be stored at certain temperatures. In the event a maximum temperature or minimum temperature has been exceeded, the biological and/or chemical substances react to form different substances, and thus may no longer be usable for the desired test. The information as to whether or not the specified temperature range has been maintained may be accessible from the temperature sensor 17 and may be retrieved by the device for reading the carrier medium 10.

Referring to FIG. 2, there illustrated is a second embodiment of a carrier medium 20. The carrier medium 20 may also be composed of an essentially rectangular film strip on which biological and/or chemical substances have been applied within the defined regions 21 of the film strip. Unlike FIG. 1, the defined regions 21 in FIG. 2 may not all be aligned in an essentially square grid 25. Some of the defined regions 21 may be located at the intersection points of the grid 25, whereas other defined regions 21 may deviate, either horizontally or vertically, from the intersection points of the grid 25. The biological and/or chemical substances may be arranged within the defined regions 21. However, due to the use of several hundred of the defined regions 21, the regions 21 are of correspondingly small size so that the naked eye may be unable to detect which biological and/or chemical substance is located in which of the defined regions 21. The pattern created by the deviations of defined regions 21 from the intersection points of grid 25 may represent a code indicating which biological and/or chemical substance is located in which of the defined regions 21.

In a method for producing the carrier media, not all of the carrier media may be identical. For example, FIGS. 3A and 3B illustrate two different carrier media 30 and 30′, respectively, that may be made from the same production process. In the method, a set of identical carrier media may be first produced with a first arrangement of biological and/or chemical substances in defined regions 31, as illustrated in FIG. 3A. The defined regions 31 may be arranged in an essentially rectangular grid. The biological and/or chemical substances are designated in FIGS. 3A and 3B by capital letters A through I. A different biological and/or chemical substance may be located in each of defined regions 31 in FIG. 3A. The carrier medium 31 may also be equipped with a temperature sensor 37.

For simplicity, the carrier medium 30 of FIG. 3A is illustrated with nine defined regions 31. However, the carrier medium 30 may have, for example, 500 defined regions 31 arranged in a grid defined by a 25×20 matrix.

In this first exemplary set of carrier media, the arrangement of the biological and/or chemical substances may be identical. However, all of the carrier media 30 in the first set of carrier media are distinguished by a code 32 which is imprinted on one of the narrower ends of carrier medium 30. For example, if code 32 is a seven-digit number, a maximum of ten million carrier media 30 could be produced with the first arrangement of biological and/or chemical substances such that each carrier medium 30 has a different code. In the present example, the first set of carrier media 30 may comprise 10,000 media which may be numbered by numerical codes 1 through 10,000. Information may be stored in the administrative center indicating that carrier media 30 with codes 1 through 10,000 have the first arrangement of biological and/or chemical substances.

In a second exemplary set of carrier media 30′ illustrated in FIG. 3B, the arrangement of biological and/or chemical substances has been modified. The biological and/or chemical substance A which in the first set of carrier media 30 in FIG. 3A in defined region 31 is located at the top left, is now located within defined region 31′ in FIG. 3B at the center of the top line. The position of each the subsequent biological and/or chemical substances B-I may also be modified. This exemplary arrangement of biological and/or chemical substances within the defined regions 31′ of FIG. 3B may be identical for all of the carrier media 30′ of the second set of carrier media. The carrier media 30′ of the second set of carrier media are similarly distinguished by a code 32′0 which may be imprinted on one of the narrower ends of carrier medium 30′. The codes 32′ may be used for the second set of carrier media 30′, and may be different from the codes 32′ used with the first set of carrier media 30. For example, the second set of carrier media 30′ may also have 10,000 media which are numbered with codes 10,001 through 20,000.

Each carrier medium thus receives a different code, although multiple carrier media may have an identical arrangement of biological and/or chemical substances within the defined regions. Each carrier medium produced is therefore different in that each medium has its own unique code. The number of possible different carrier media may be determined by the number of biological and/or chemical substances on the carrier medium and by the maximum number of different codes. If a carrier medium has 500 different biological and/or chemical substances, the result is 500! different arrangements for the biological and/or chemical substances, whereby in the case of a seven-digit numerical code ten million different codes may be provided for each arrangement.

To ensure that, after the production of, for example, 200 sets of carrier media with the same arrangement, carrier media having different arrangements of biological and/or chemical substances may be contained in one pack, 100 sets for example may be randomly selected from the 200 sets, and from these 100 sets one carrier medium each may be selected, after which the carrier media thus selected may be packed in one pack. The selection of the sets and carrier media may be implemented using a random number generator.

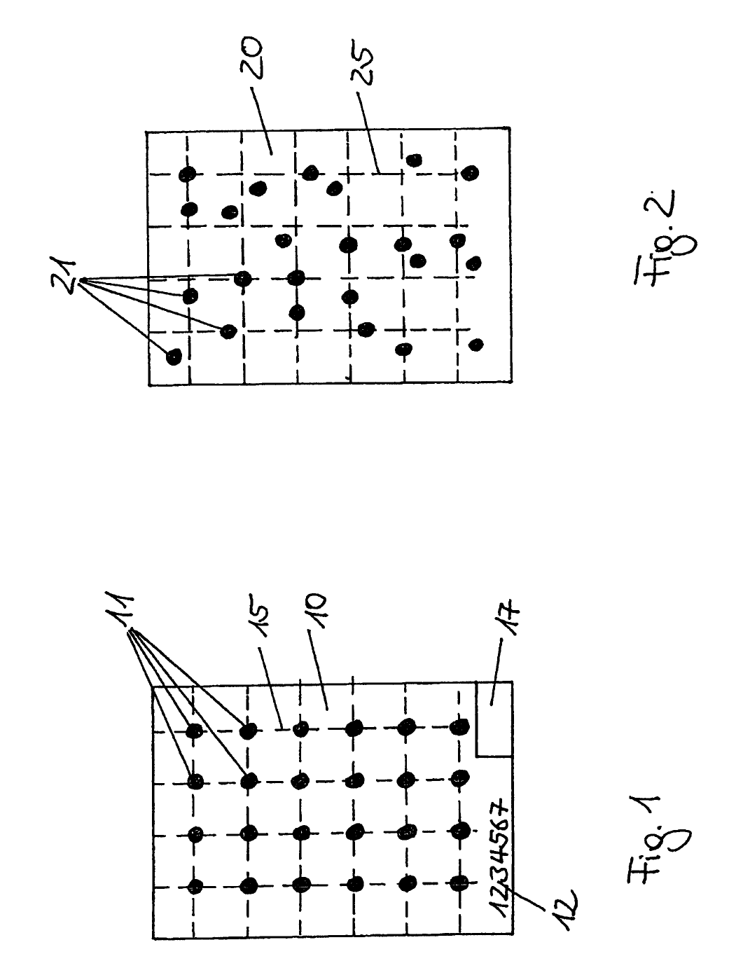

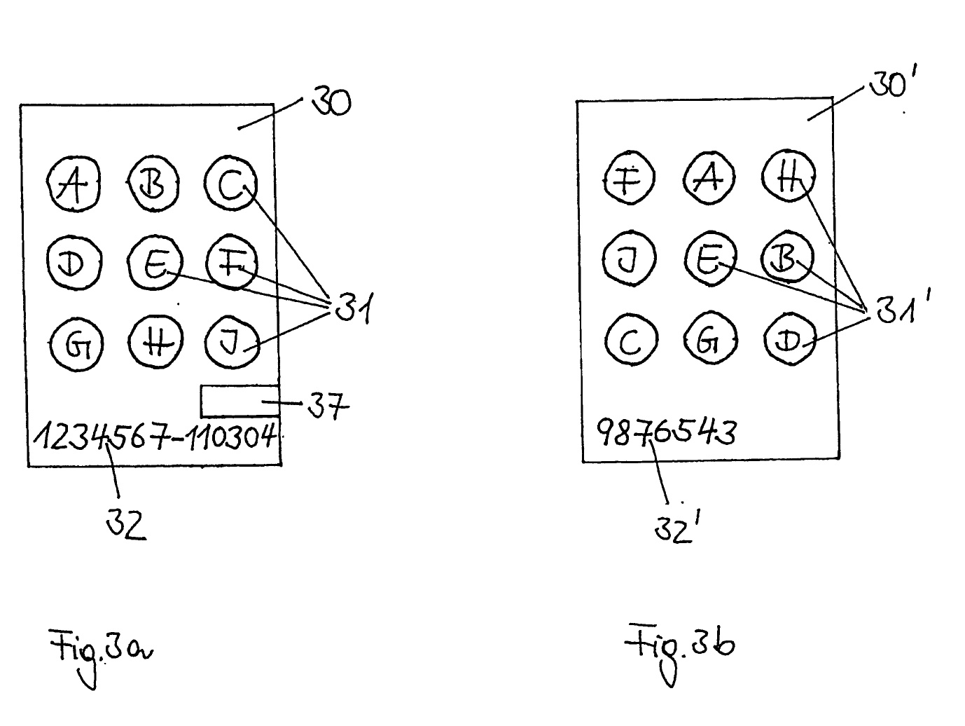

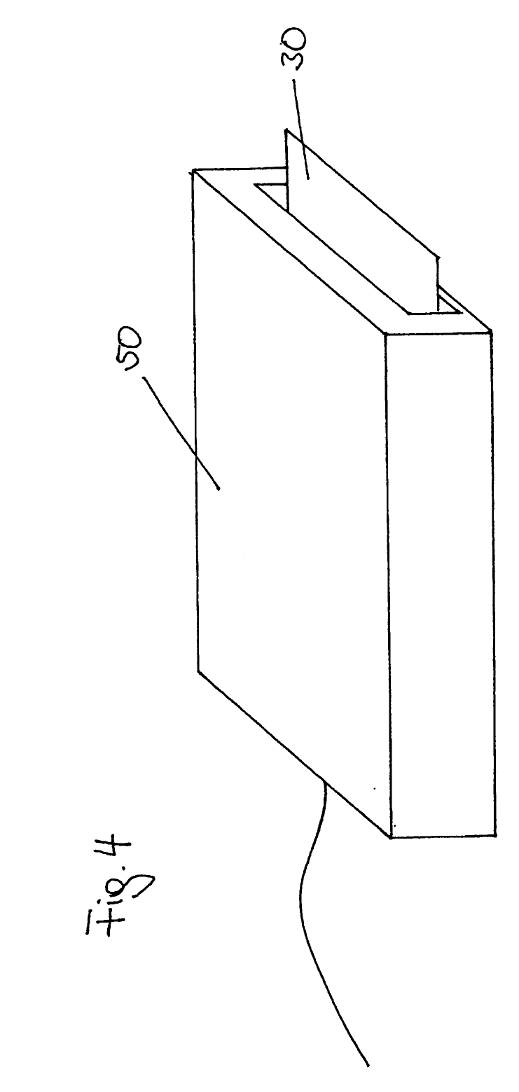

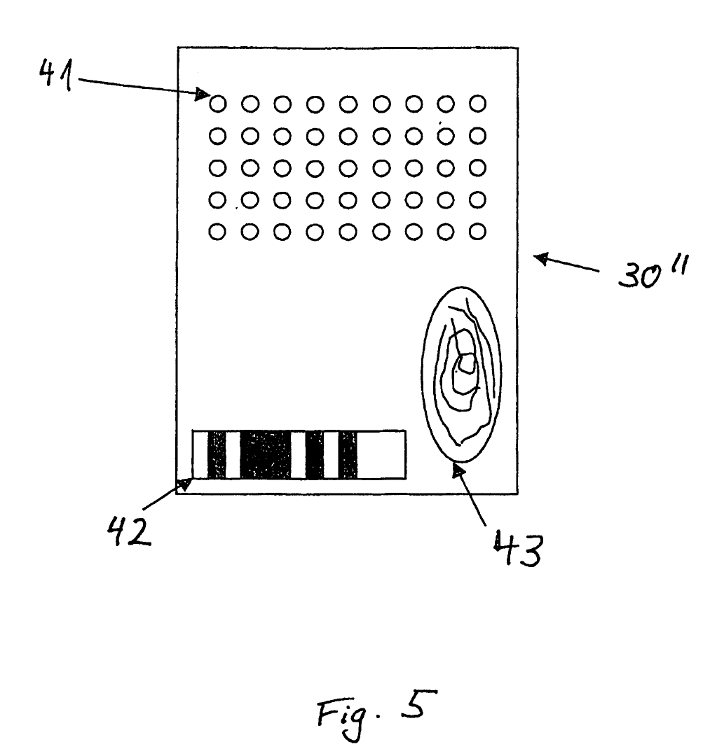

Use of the carrier media comprises applying an analyte, for example the blood or urine of a patient, to the surface of the carrier medium. Biological and/or chemical substances which may be used include DNA, RNA, proteins, and antibodies. If the analyte contains the corresponding “counterpart”0 to the biological and/or chemical substance, a reaction takes place which is generally manifested as a change in color of the corresponding defined region. The color changes may, for example, lie in the visible region of the spectrum, or they may also lie within the infrared or ultraviolet regions. Given that there are several hundred defined regions on one carrier medium the size of a credit card, it may not be possible for the naked eye to detect the reactions of the analyte with the biological and/or chemical substances. Thus referring to FIG. 4, the carrier medium 30 may be placed, after application of the analyte, into a device 50 for reading the carrier medium. The device 50 may have drive system, analogous to a disk drive, in which carrier medium 30 is moved into the read position relative to the device 50. Once the carrier medium 30 is in the read position, optical detectors, for example semiconductor chips, are located above the individual defined regions 31, which detectors detect the color changes of defined regions 31. However, the device 50 may not be capable of assigning the detected signals to the biological and/or chemical substances A through I applied to defined regions 31 of the carrier medium 30 of FIG. 3A. For this purpose, a means may be attached to device 50 which reads code 32 of carrier medium 30 and transmits it to the administrative center.

In a first method, the detected signals for defined regions 31 are transmitted along with the code 32. The assignment of relating the code 32 to the arrangement of biological and/or chemical substances A through I within the defined regions 31 of the different carrier media 30, 30′ may be stored in the administrative center. Thus, the administrative center may determine for which biological and/or chemical substances A through I a reaction has taken place with the analyte. The administrative center may then send the result back to the device 50 and, depending on the situation, may indicate whether additional carrier media, such as those with different biological and/or chemical substances, are to be analyzed. For example, if on the initially analyzed carrier medium a positive reaction has been found for a certain biological and/or chemical substance, it may be appropriate to analyze the analyte for additional biological and/or chemical substances which were not present on the first carrier medium. In addition, the administrative center may be able to instruct the device 50 for reading a carrier medium as to how the optical detectors should be located in regard to the given arrangement of biological and/or chemical substances A through I. If necessary, testing may be repeated on the carrier medium 30 using the located optical detectors.

In a second method, the device 50 may first read the code 32 of the carrier medium 30 and then may send the code to the administrative center. The administrative center may determine the associated arrangement of biological and/or chemical substances A through I from the code 32 and may then instruct the device 50 as to how the optical detectors for this carrier medium 30 should be located. The device 50 may then perform the read procedure and detect the color signals emitted by defined regions 31. These may be subsequently sent to the administrative center which may determine whether, and if so which, of biological and/or chemical substances A through I have reacted with the analyte.

On the carrier medium 30, information may be provided within the code 32 about the expiration date of the carrier medium 30, which information is, for example, present as a supplementary six-digit code number attached to the seven-digit code number 32 containing the information about the arrangement of biological and/or chemical substances A through I within defined regions 31. The device 50 may read this code and issue a warning if the expiration date has already been passed.

In addition, the device 50 may read the information from temperature sensor 37 and may issue a possible warning if the specified maximum or minimum temperature has been exceeded at any time while the carrier medium 30 was stored.

Transmission of the data from the device 50 to the administrative center may proceed after the data has been encrypted using a public key. This key may be provided by the administrative center, and thus only the administrative center may be able to decrypt the data. In addition, transmission of the data may be error-protection-coded so that any transmission errors may be immediately discovered and eliminated.

To finance the production of the carrier media and, specifically, the biological and/or chemical substances, while at the same time providing the most inexpensive possible medical screening test for any person, provision may be made whereby the evaluation of the codes and determination of the associated arrangement of the carrier media may be performed at no charge within the administrative center, and a fee may be charged only if one of the biological and/or chemical substances has reacted with the analyte.

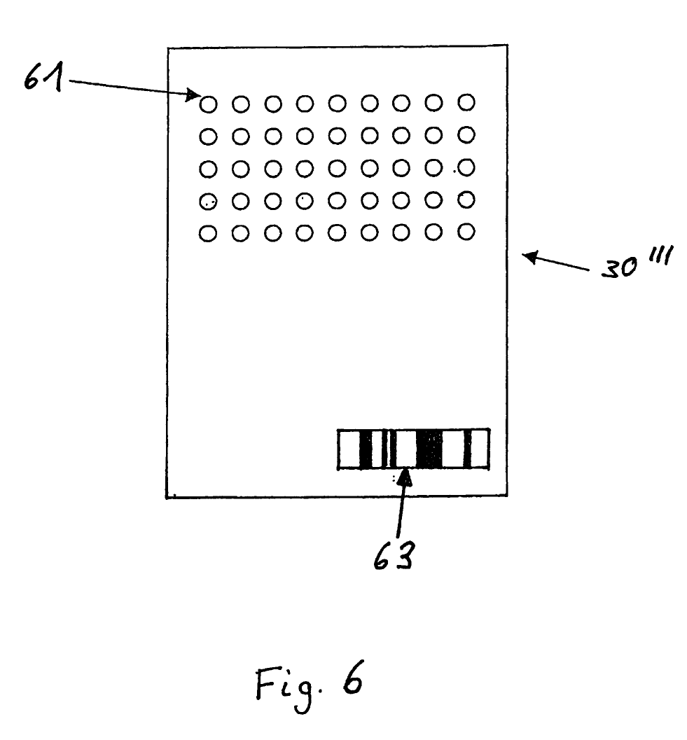

FIG. 5 shows an embodiment of a carrier medium 30″ on which biological and/or chemical substances are again arranged on defined regions 41, and which is provided with a code 42 indicating which biological and/or chemical substance is located in which of the defined regions 41. In addition, an additional code 43 is provided on carrier medium 30″ which serves to assign carrier medium 30″ to a person or group of persons.

In the present embodiment, this additional code 43 is implemented in the form of a fingerprint which may, for example, be the fingerprint of the patient whose blood or other substance is being examined using the carrier medium 30″.

A fingerprint sensor is located in the device 50 (FIG. 4) for evaluating the carrier medium 30″, where the sensor reads the fingerprint 43 representing the additional code. In the event the additional code 43 instead involves another type of code, for example, a bar code, then of course a sensor capable of reading this code must be provided in the device 50.

For example, if the additional code 43 relates to the fingerprint of a patient, after this has been read in the device 50 the carrier medium 30″ and the color changes detected in the defined regions 41 can be automatically assigned to the patient, and optionally compared with earlier measurement results.

FIG. 6 shows an embodiment of a carrier medium according to the invention 30′″ which has a code 63 in the form of a bar code that is assignable to a person or group of persons. In addition, the carrier medium 30′″ is again provided with biological and/or chemical substances arranged within the defined regions 61. Here no code is provided indicating which biological and/or chemical substances are located in which of the defined regions 61.

This aspect can be useful, for example, whenever the biological and/or chemical substances are always arranged within the defined regions 61 in the same way, and the only requirement is that there be an assignment of the carrier media 30″, or of the color changes detected within the regions 61 in the device 50 in FIG. 4, to a person or group of persons. These persons may include, for example, patients, attending physicians, a group of diabetes patients, or the like.

Accordingly, a sensor unit adapted to the code 63 is provided in the device 50 of FIG. 4, the unit being able to read this code 63, which in this embodiment is implemented as a bar code. Subsequent to this action, the color changes detected in the device 50 within the defined regions 61 can be automatically assigned to the associated person or group of persons, then further processed appropriately. When an assignment to a patient is effected based on the code 63, it is possible, for example, to implement an automatic matching of the detected color changes with previous measurement results from the same patient.

Although the present invention has been illustrated and described with respect to several preferred embodiments thereof, various changes, omissions and additions to the form and detail thereof, may be made therein, without departing from the spirit and scope of the invention.

What is claimed is:

1. A carrier medium for analyzing an analyte, to which at least one substance is applied in at least two defined regions, with a code showing which of the at least one substance is located in which of the at least two defined regions.

2. The carrier medium of claim 1, where at least several hundred substances are applied in a corresponding number of the defined regions.

3. The carrier medium of claim 1, where the at least one substance is disposed differently in the defined regions on two different carrier mediums.

4. The carrier medium of claim 1, where the defined regions are disposed differently on two different carrier mediums.

5. The carrier medium claim 1, further comprising a temperature sensor.

6. The carrier medium of claim 1, where the code is from the group comprising a one-dimensional or two-dimensional bar code, a numerical, or an alphanumeric code, and the arrangement of the defined regions on the carrier medium.

7. The carrier medium of claim 1, where at least one code is provided which is assigned or assignable to a person or group of persons.

8. The carrier medium of claim 7, where at least one of the additional codes is integrated in the code indicating which of a certain substance is located in which of the defined regions.

9. The carrier medium of claim 7, where at least one of the additional codes comprises a fingerprint.

10. The carrier medium of claim 1, where the code provides information for a device reading the carrier medium as to how the device should read which of the defined regions.

11. The carrier medium of claim 1, where the code contains information indicative of the expiration date of the carrier medium.

12. The carrier medium of claim 1, where the code contains information on the storage of the carrier medium from the time the carrier medium is manufactured until the time the carrier medium is used.

13. The carrier medium of claim 1, where the carrier medium is composed of a material from the group comprising a film, glass carrier, or paper.

14. The carrier medium of claim 1, where the at least one substance is from the group comprising biological substances and chemical substances and where the group comprising biological substances and chemical substances comprises a substance from the group comprising DNA, RNA, proteins, and antibodies.

15. A method for manufacturing a carrier media comprising the steps of:
a. producing a set of carrier media having a first arrangement of at least one physical characteristic of the carrier media;
b. assigning a different code to each of the carrier media in the set;
c. storing the first arrangement along with the associated code;
d. selecting a second arrangement of the at least one physical characteristic of the carrier media that is different from the first arrangement;
e. implementing steps a through c for the second arrangement; and
f. implementing steps a through c for subsequent arrangements different from the arrangements previously used.

16. The method of claim 15, where the code comprises a numbering of each one of the carrier media.

17. The method of claim 15, where the at least one physical characteristic of the carrier media is an arrangement of at least one substance within a defined region on each one of the carrier media, and where the at least one substance is printed within the defined region using an inkjet printing process.

18. The method of claim 15, where the set of carrier media comprises approximately 1,000 to 10,000 carrier mediums.

19. The method of claim 15, where several hundred sets of the carrier media are manufactured.

20. The method of claim 15, where one carrier medium each is selected from different sets of the carrier media and the selected carrier mediums are packed together.

21. The method of claim 15, where a plurality of the sets of the carrier mediums are mixed together and the carrier mediums are randomly selected from the mixed sets of the carrier media for inclusion in a common pack.

22. A device for reading a carrier medium, having at least one optical detector per defined region on the carrier medium, wherein each optical detector detects reactions of certain substances in the defined regions on an analyte and provides corresponding when as the carrier medium is in a read position relative to the device.

23. The device of claim 22, where the carrier medium includes a code, and where the device further comprises means for acquiring and transmitting the code to an administrative center.

24. The device of claim 22, where the optical detector is a semiconductor chip.

25. The device of claim 22, further comprising means for digitizing the detected signals.

26. The device of claim 22, further comprising means for transmitting the detected signals to the administrative center.

27. A method for reading a carrier medium comprising the steps of:
a. applying an analyte to the carrier medium, the carrier medium having at least one defined region;
b. moving the carrier medium into a read position relative to a device for reading the carrier medium;
c. transmitting a code of the carrier medium to an administrative center;
d. within the administrative center, evaluating the code and determining an associated arrangement of the carrier medium.

28. The method of claim 27, where in step d, the steps of the evaluating the code and the determining the associated arrangement within the administrative center are performed by the administrative center at no cost and a fee is charged if the analyte has reacted positively to one of certain substances located in one of the at least one defined region on the carrier medium.

29. The method of claim 27, where instructions are transmitted from the administrative center to the reading device as to how at least one optical detector is to be set for the at least one defined region.

30. The method of claim 27, further comprising the step of:
e. detecting reactions of each of the at least one defined regions using the at least one optical detector and providing a detected signal indicative thereof.

31. The method of claim 30, further comprising the step of :
f. transmitting the detected signals to the administrative center.

32. The method of claim 31, further comprising the step of:
g. transmitting the associated arrangement of the carrier medium from the administrative center to the device, and reading the transmitted associated arrangement.

33. The method of claim 27, where step b further comprises the step of detecting the reactions of each of the at least one defined region using at least one optical detector and providing a detected signal indicative thereof, and where step c further comprises the step of transmitting the detected signals to the administrative center.

34. The method of claim 33, further comprising the step of:
e. transmitting the associated arrangement of the carrier medium from the administrative center to the device.

35. The method of claim 30, where instructions are transmitted by the administrative center to reset a certain one of the at least one defined regions according to the detected signals.

36. The method of claim 30, where a request is sent by the administrative center, in response to the detected signals, to read another carrier medium having an associated arrangement that is different from the associated arrangement on the first carrier medium after application of the analyte.

37. The method of claim 30, where the detected signals and the code for transmittal to the administrative center is keyed with a public key.

38. The method of claim 27, where the transmission of the detected signal and the code to the administrative center is error-protection-coded.

39. A carrier medium for analyzing an analyte on which certain substances are applied in at least two defined regions, having at least one code which is assignable to a person or group of persons.

40. The carrier medium of claim 39, where at least one of the codes comprises a fingerprint.
